(19) United States
(12) Patent Application Publication
(10) Pub. No.: US 2014/0181882 A1
(43) Pub. Date: Jun. 26, 2014

(54) Method for transmitting metadata documents associated with a video

(71) Applicant: CANON KABUSHIKI KAISHA, Tokyo (JP)

(72) Inventor: FRANCK DENOUAL, SAINT DOMINEUC (FR)

(73) Assignee: CANON KABUSHIKI KAISHA, Tokyo (JP)

(21) Appl. No.: 14/136,146

(22) Filed: Dec. 20, 2013

(30) Foreign Application Priority Data
Dec. 24, 2012 (GB) 1223384.7

(51) Int. Cl. H04N 21/236; H04N 21/845; H04N 21/8543

(52) U.S. Cl. CPC H04N 21/23614; H04N 21/8543; H04N 21/8451
USPC 725/116

(57) ABSTRACT

A method of transmitting metadata document associated with a video, each metadata document comprising format information and time information, comprising the steps of:
identifying, within every metadata document, distinct elements by their format information and storing elements of equivalent format within sets;
multiplexing, within each set, elements of common time information;
compressing at least one of the said multiplexed elements; and
transmitting a bit-stream containing said at least one multiplexed element.

This application claims the benefit under 35 U.S.C. §119(a)-(d) of United Kingdom Patent Application No. 1223384.7, filed on Dec. 24, 2012. The above cited patent application is incorporated herein by reference in its entirety.

### FIELD OF THE INVENTION

The present invention concerns a method of transmitting metadata documents associated with a video, more particularly Web-accessed videos.

### BACKGROUND OF THE INVENTION

Web-accessed videos are increasingly enriched by the addition of synchronized metadata documents that may enrich the presentation. Examples of such metadata documents are subtitles for a movie, lyrics for a song or user annotations.

Other applications may also include clickable videos in Web pages. These allow users to click onto a video frame area to zoom on a particular region of interest, go to a Web page associated to the video content being displayed, display biography information on characters or an ad for a product in a movie, etc.

Synchronized delivery and display of such metadata documents provides users with an enriched viewing experience.

Many different devices enable users to connect to the Web to browse, share, annotate or edit videos as described above.

Such devices may include W3C (World Wide Web Consortium) HTML5 (Hyper Text Markup language) framework and adaptive HTTP (Hyper Text Transfer Protocol) streaming for streaming videos on the Web.

Web video applications enabling video interaction (embedded videos) are usually written using this format, coupled with CSS (Cascading Style Sheets) for styling and javascript code for interacting with page elements.

At the present time, the current way for a streaming client—typically a Web browser—to download enriched video content is to parse the HTML5 page, to identify all the resources embedded in the page, to load the metadata documents, and then to progressively load the video.

As the metadata documents become bigger and bigger, this can introduce a startup delay in video browsing.

Moreover, on the client side, it is necessary to build an in-memory representation of the downloaded metadata documents and to have it available along the whole page browsing duration—this is not an optimal use of the client's available memory considering the video-related metadata documents may be only relevant at a given point in time during the video, when it is synchronized with some of the video frames.

U.S. Pat. No. 7,376,155 discloses a method for delivery of metadata synchronized to multimedia content comprising the steps of compressing the generated multimedia content, converting metadata into a synchronization format for synchronization with the multimedia content and then multiplexing the multimedia contents format and the metadata format into a stream.

### SUMMARY OF THE INVENTION

In order to address at least one of the issues discussed above, it is an object of the present invention to provide a method for transmitting metadata documents associated with a video, for testing the configuration of an encoder for compression or precision and computing the encoded metadata accordingly, and for a method for receiving the metadata and restoring them to their original format.

In one aspect of the present disclosure, a method of transmitting metadata documents associated with a video, each metadata document comprising format information and time information, comprises the steps of:
identifying, within every metadata document, distinct elements by their format information and storing elements of equivalent format within sets;
multiplexing, within each set, elements of common time information;
compressing at least one of the said multiplexed elements; and
transmitting a bit-stream containing said at least one multiplexed element.

The main advantage of the proposed disclosure is to provide efficient transmission of the metadata documents associated with the video.

Unlike what has been proposed by the prior art, multiplexing of the metadata documents is done before the compression step. This allows to compress the structure of the metadata documents by grouping them into a reduced set of metadata frames.

In a particular embodiment, the multiplexing step includes the mapping of the elements from a same set onto an abstract representation format.

This enables to group and synchronize metadata in a same time interval.

In a particular embodiment, the method comprises the additional step of choosing between at least two different multiplexing algorithms.

In a particular embodiment, the multiplexing algorithm consists in assembling elements of equivalent format into a single frame element defined by the union of the intersections of the time intervals found between the time information of said elements of equivalent format.

This corresponds to a so-called “lax” synchronization. Such an algorithm is particularly well-suited to efficient compression, since it reduces the number of time intervals to compress.

Alternatively, the multiplexing algorithm consists in assembling elements of equivalent format into one or more frame elements defined by the intersection of the time interval found between the time information of said elements of equivalent format.

This corresponds to a so-called “strict” synchronization. Such an algorithm is particularly well-suited to precise synchronization.

In a particular embodiment, a plurality of the multiplexed elements is grouped into segments and the compressing is performed independently on each segment.

The size of the segment may be based upon the video segments duration provided in the video multimedia documents.

In a preferred embodiment, the segment compression is performed using the Efficient XML interchange format.

In a particular embodiment, the number of multiplexed elements within a segment is based upon the segment duration information provided in a multimedia document containing a description of the video.

In a particular embodiment, the size of such segments may be used as a criterion for compressing, by using the self-contained option of the EXI format, for more than one element.

In order to do so, an extension of a standard EXI compressor may be used.

In a particular embodiment, each value of the elements in the segment are further compressed using a deflate algorithm.

In a particular embodiment, the values of the elements in the segment are encoded using the compression option of the efficient XML interchange format.

Access granularity can therefore be controlled and compression efficiency may be preserved since the encoder can preserve structure and value knowledge to encode new frames “differentially” from already encoded ones.

Moreover, each segment becomes addressable and accessible independently from the other segments. Bandwidth is thus saved because only relevant metadata documents for a given time period are transmitted.

According to another aspect of the present disclosure, a metadata transmitter for synchronizing metadata documents associated with a video, each metadata document comprising format information and time information, comprises:
an identifier for identifying, within every metadata document, distinct elements by their format information and storing elements of equivalent format within sets;
a multiplexing encoder for multiplexing, within each set, elements of common time information;
a compressor for compressing at least one of the said multiplexed elements; and
a transmitter for transmitting a bit-stream containing said at least one multiplexed elements.

According to yet another aspect of the present disclosure, a method of receiving metadata associated with a video that is described in multimedia documents, comprises the steps of:
receiving compressed multiplexed elements of metadata documents;
un-compressing the received multiplexed elements;
reconstructing different metadata documents from the obtained multiplexed elements;
associating these metadata documents to the corresponding video multimedia documents for rendering.

The aspects and characteristics of the present disclosure are described in the claims.

### BRIEF DESCRIPTION OF THE DRAWINGS

Embodiments of the invention will now be described, by way of example only, and with reference to the following drawings in which:

FIG. 1 shows an exemplified download of a video and its associated metadata according to a preferred embodiment of the present invention;

FIG. 2 shows a flowchart of a method for transmitting metadata documents associated with a video according to a preferred embodiment of the present invention;

FIG. 3 shows a metadata multiplexing encoder according to a preferred embodiment of the present invention;

FIG. 4 shows a flowchart of a step for identifying metadata documents according to the method of FIG. 2;

FIG. 5 shows a flowchart of a step for assembling metadata documents according to the method of FIG. 2;

FIG. 6 shows a flowchart of a step for compressing metadata documents according to the method of FIG. 2;

FIG. 7 shows an example of metadata track mapping according to the method of FIG. 2.

FIG. 8 shows a chart showing the compression efficiency between different compression modes.

### DETAILED DESCRIPTION

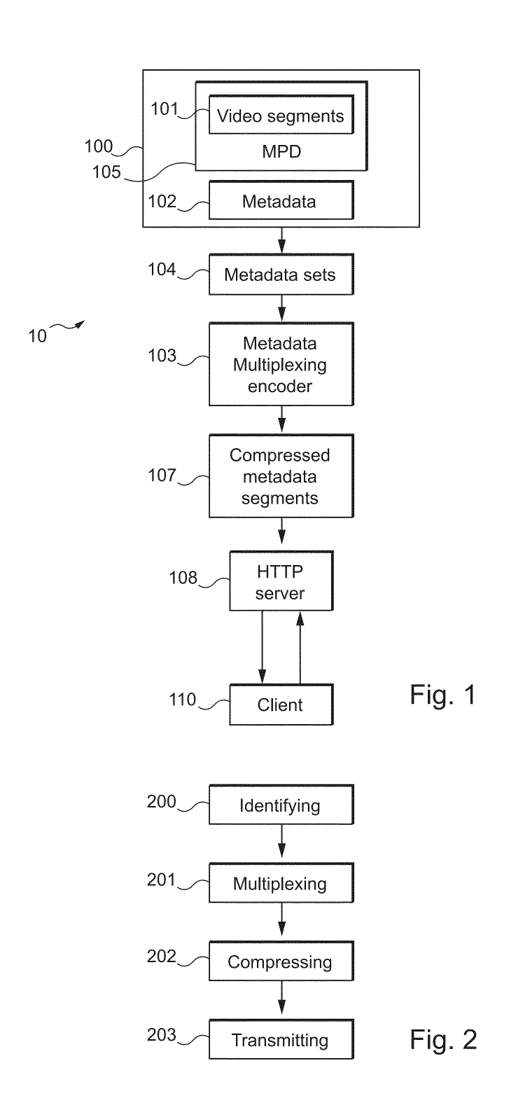

In FIG. 1 the exemplified download of a video and its associated metadata according to a preferred embodiment of the present invention is schematically depicted.

As shown, video segments 101 and associated metadata documents 102 are embedded in a Web page 100.

In the present embodiment, it is for example assumed that the video segments 101 are described in a manifest file 105 (for example a Media Presentation Description as specified by the 3GPP/MPEG/DASH standard). More particularly, these video segments may be generated in an mp4 format.

Web page 100 is for example written in HTML5 and potentially embedding javascript code to enable users to interact with its contents.

It is made available for metadata multiplexing encoder 103 that will apply a method for transmitting metadata documents associated with a video according to the present invention, in order to upload compressed metadata segments 107 ready for synchronous streaming to a HTTP server 108 requested by a client 110. For instance, client 110 is either an HTML5 player or a Web browser.

FIG. 2 shows a flowchart of a method for transmitting metadata documents associated with a video according to a preferred embodiment of the present invention.

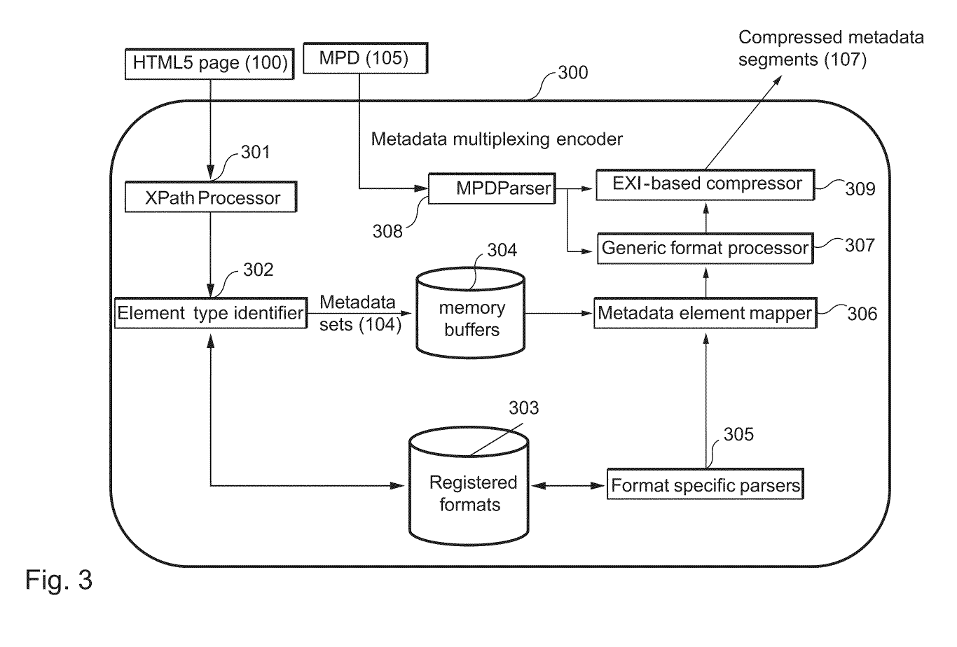

Each of these steps is performed by the metadata multiplexer encoder 300 illustrated on FIG. 3. From now on, FIG. 2 and FIG. 3 will be referred to in all the remaining detailed description.

The first step in the metadata documents transmission consists in an identifying step 200 during which distinct elements of metadata documents contained in Web page 100 are identified by their format information.

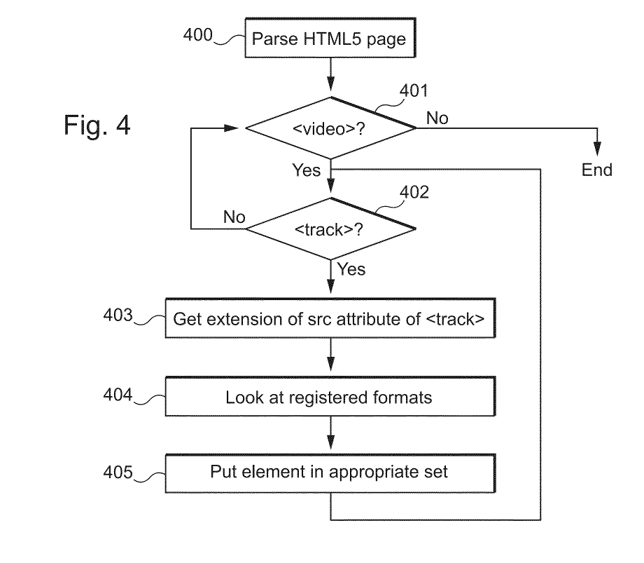

FIG. 4 shows a flowchart of the sub-steps contained within identifying step 200.

The first of these sub-steps is step 400 which consists in parsing the HTML5 page.

Then, for each parsed element, step 401 checks whether it corresponds to a <video> tag.

If so, during step 402, each <video> element is searched for child elements with the <track> tag.

Then, during step 403 the “src” attribute of the <track> element, or any attribute value that may specify the address (URL) of the element within Web page 100, is looked for.

Reaching the “src” attribute of the <track> element can be performed by an XPath processor (module 301 on FIG. 3.) by evaluating XPath expressions such as fivideo/track/Εsrc.

More particularly, step 403 consists for XPath processor 301 in extracting the extension via, for example, the XPath expression or by a regular expression processor that will extract the string following the last dot (“.”) character in the value of the src attribute. The value of this src attribute also indicates the corresponding metadata document to classify.

Once extracted, the extension is compared by a track type identifier module 302.

This consists in comparing the provided extension with a set of registered formats in database 303.

This database can be filled with “hard-coded values” that refer to well-known metadata standards, e.g. WebVTT, SMPTE-Timed Text, W3C Timed Text . . . etc.

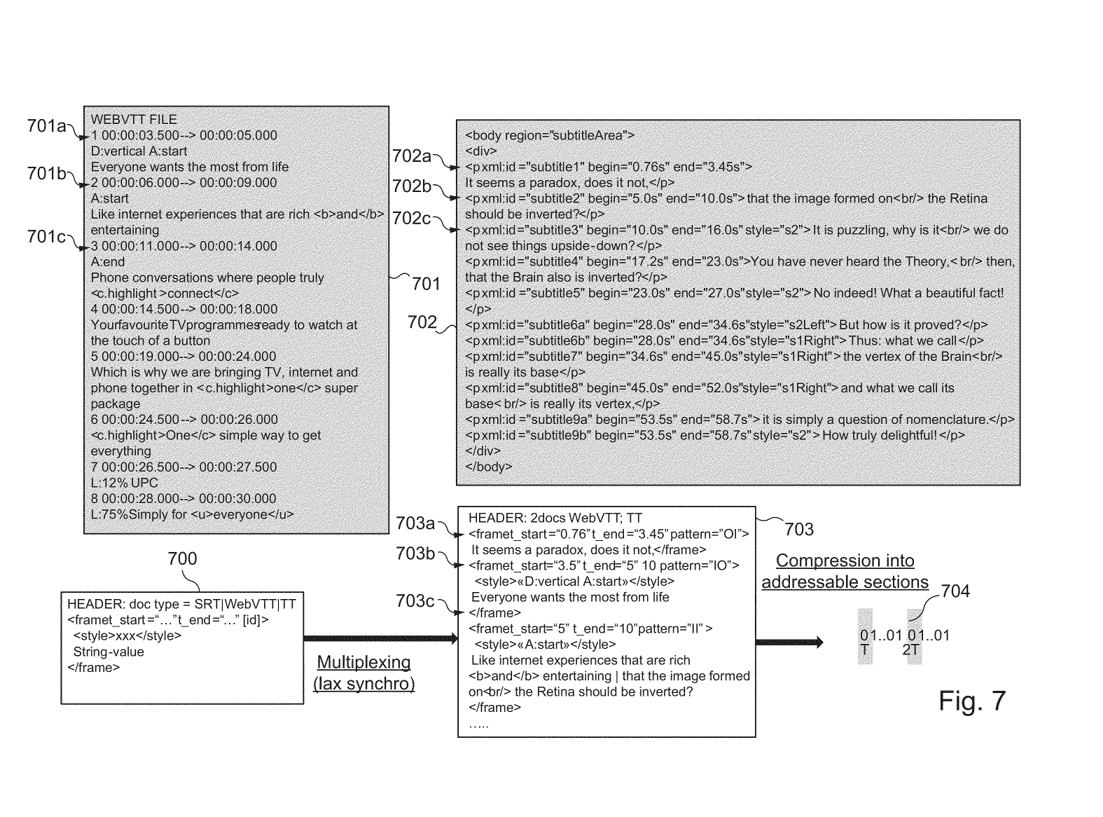

An example of metadata elements of equivalent format is provided on FIG. 7 through files 701 and 702

Files 701 and 702 are instances of different timed text metadata documents, referenced in track elements and including time information.

File 701 is a WebVTT file while file 702 is a W3C Timed Text file.

The elements within those files are considered of equivalent format and can therefore be stored in database 303 of the metadata multiplexing encoder 300.

Database 303 is organized so that it not only provides registered formats, but also sets of equivalence between some registered formats.

Once step 403 is over, during step 404, a set of formats that are equivalent to the current one are identified. This step is also performed by track type identifier 302.

The corresponding metadata element is then put in the appropriate set, i.e. the set containing metadata element of equivalent format.

Track type identifier 302 does so by storing the metadata elements sets 104 thus identified in a temporary memory buffer 304.

Once all <video> elements and <track> elements have been processed (steps 401 and 402 returning false), a metadata element (track) classification is obtained.

It has to be noted that when multiple videos are present in HTML5 page 10, classification as described hereinbefore is performed for one video at a time.

Indeed, in order to preserve the association between one video and its tracks, equivalent metadata elements of two different videos will not be classified in the same set.

In such case, the metadata elements sets will be stored annotated with a video ID, for instance within memory buffer 304.

At the end of identifying step 200, multiplexing step 201 may start.

A purpose of multiplexing step 201 is to map the elements from the metadata documents onto an abstract representation format that defines timed metadata frames.

Such an abstract format may be made up of a header indicating the number of multiplexed elements with their formats.

In addition, the said format would include a list of <frame> elements containing timing information, such as the t_start and t_end attributes to indicate the period of time onto which the metadata elements are relevant.

An example of such a header is shown on FIG. 7 through header 700.

Considering the elements contained within files 701 and 702 are of equivalent format, they may be mapped onto abstract syntax or header 700.

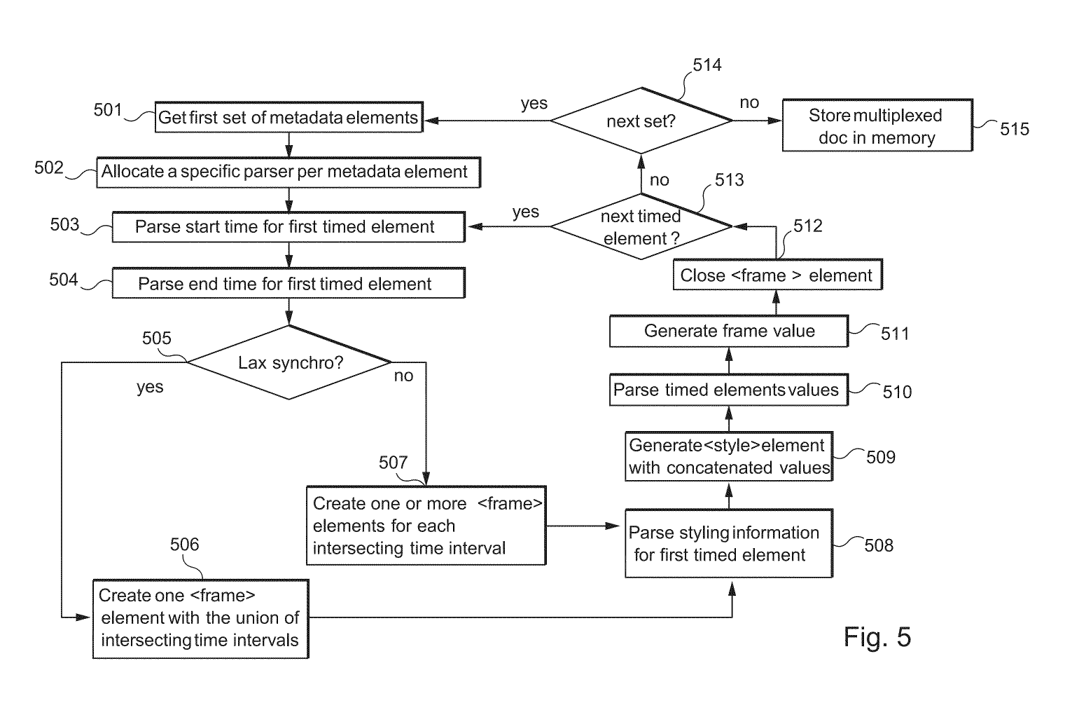

FIG. 5 describes the sub-steps of multiplexing (or mapping) step 201. Such a step is performed by metadata element mapper 306 of metadata multiplexing encoder 300.

It is meant to multiplex elements of common time information.

The first sub-step 501 consists in obtaining different sets of classified metadata elements. For metadata element mapper 306, they are obtained from the memory buffer 304.

For each metadata element (track) in the set, a dedicated parser is allocated from a set of registered standard format parsers 305 during sub-step 502.

In parallel with sub-step 502, parsing starts for each metadata element of the current set by parsing the first start time information at step 503.

In addition, during sub-step 504, parsing the first end time information for the first timed items in the different elements is performed, such as the <p> item in Timed Text element 702 and the item 1 in WebVTT element 701 (on FIG. 7).

Sub-step 505 corresponds to testing whether the metadata multiplexing encoder is configured to optimize compression or to synchronize with precision. In other words, sub-step 505 tests for so-called “lax” or “strict” synchronization.

Depending on the result of this test, the mapping of the metadata elements onto a representation format, i.e. the computation (creation) of abstract frame elements is done respectively according to the appropriate algorithm.

Should the encoder be best configured for compression (“lax” synchronization), step 506, corresponding to the creation of abstract frame elements with the union of intersecting time intervals, is performed.

Conversely, should the encoder be best configured for precise synchronization, step 507, corresponding to the creation of abstract frame elements for each intersecting time interval, is performed.

Regardless of which of these two steps is taken, the creation of an abstract frame element consists in appending a <frame> element in the temporary abstract element resulting from the multiplexing.

For example, generic format processor 307 may append a frame element to the temporary abstract XML element 703 on FIG. 7.

In addition, for each frame element, start and end time (t_start and t_end) attributes are set in accordance with the values of the computed time intervals that have been determined by the chosen algorithm (lax or strict).

In addition, and as last mandatory attribute, a flag is set to indicate, in the set of metadata elements, which ones have a value encoded for the given frame.

Said flag may be a fixed length code word, the number of bits of which is the number of multiplexed metadata tracks.

VLC code may also be used to encode this information through the use of common Huffman tables between metadata multiplexing encoder and the streaming clients. This solution would fit closed/proprietary solutions or would require the tables to be encoded as initialization information or transmitted with a dedicated protocol.

An optional attribute ID can also be used to facilitate the identification of the abstract frames elements.

An example of the application of the “lax” synchronization algorithm according to sub-step 501 can be seen on FIG. 7.

For the first frame timed element 703a, no time intersection occurs between the two timed elements 701a, 702a. Therefore, first frame timed element 703a only benefits from an input from file 702.

Conversely, and for similar reasons, second frame timed element 703b only contains data from file 701, that is, from timed element 701b.

Third frame timed element 703c shows an example of multiplexed values from both file 701 and 702, that is, from both timed elements 701c and 702c.

Moving on to step 508, styling information associated with a frame element (such as for element 703 on FIG. 7) may be gathered from the metadata elements through parsing, for example through parser 305.

This styling information is generated into the abstract multiplexed document at step 509 by the generic format processor 307.

The string-values for the timed items in the metadata elements are then parsed by the format specific parsers 305 at step 510 and inserted into the abstract document at step 511 as a text child of <frame> element. These values are inserted as a list of concatenated string values.

Finally, the frame element is closed at step 512 by generic format processor 307.

The method then loops to the next timed element during step 513 until all timed elements have been parsed, that is, until the test performed in step 514 which looks for any remaining metadata set is negative.

It should be noted that in a preferred embodiment corresponding to FIG. 5, the decision to perform lax or strict synchronization is left to the author/content provider.

In another embodiment however, metadata element mapper 306 may systematically generate two multiplexed elements: one for the lax synchronization and one for the strict synchronization.

This would provide alternate versions for compressed metadata streams (as may be the case for video streams) or would enable bitrate regulation by the EXI-based compressor 309.

The bitrate regulation and the choice for synchronization may, for an online embodiment, be performed “on the fly” by the EXI-based compressor 309 the lax criterion would be adjusted dynamically according to the allocated rate for metadata streams.

Moving back to FIG. 2, the last step of the metadata content preparation before streaming consists in compressing (step 202) the multiplexed metadata elements that have been assembled into frames as described hereinbefore.

Before that, multiplexed elements are grouped into segments.

This process is achieved by the EXI-based compressor 309 of the metadata multiplexing encoder 300. It should be noted that in other embodiments, the compressor may use another compression method.

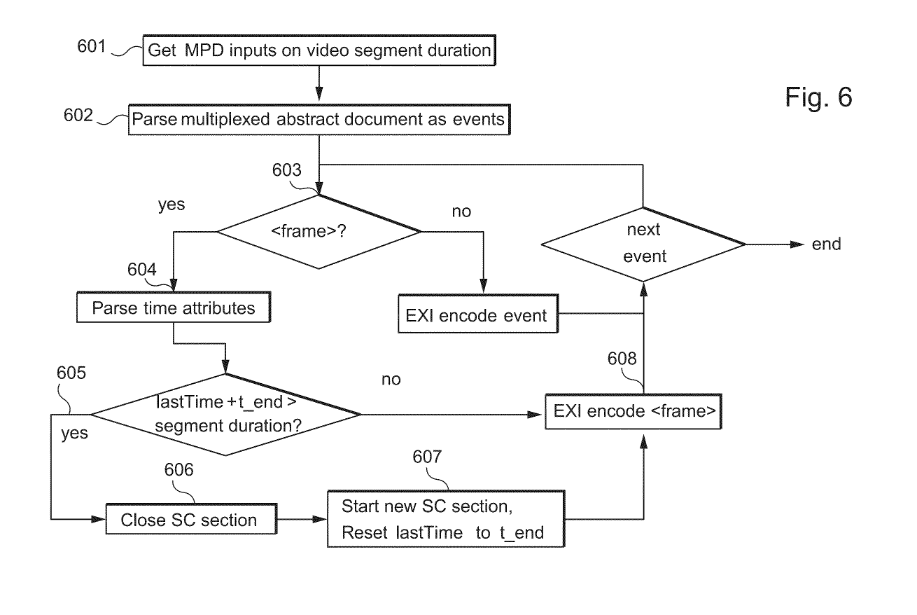

FIG. 6 describes the sub-steps of the compression process.

First, Media Presentation Description (MPD) parameters are recovered during step 601 using the MPD parser 308 in order to be taken as input for EXI-based compressor 309.

According to the present disclosure, the parameters used by the EXI-based compressor 309 are the value of the <Period> element contained in the MPD105 as well as the video segment duration information.

Then, the compression may start by parsing, into a list of events, (step 602) first frame timed element of the abstract multiplexed element that has been stored in memory buffer 604 by the metadata element mapper 306 at step 515.

This is performed by EXI compressor 309 which is specifically provided with XML events to encode by generic format processor 307 that is able to parse the abstract metadata format 700.

The parser then looks for frame elements (step 603) and for timing attributes “t_start” and “t_end” in 700.

These attributes are then parsed at step 604 so as to indicate when to end a SC (self-contained) section and when to start a new one (step 607).

To this purpose, metadata element mapper 306 maintains the start time at which it decided to create a new SC section.

The start time value is then incremented by the value of the end time of each encoded frame element.

During test step 605, such a value is compared to the video segment duration provided by the MPD Parser 308.

Should the reached current time be greater than the segment (positive test) duration, the current SC section is closed at step 606 by generating an ED (end document) event in the EXI stream.

A new SC section is then immediately created in step 607. This new section rests the current time to the value of the frame end time.

Then, a metadata segment with subsequent frame elements is created at step 608.

Conversely, should the reached current time be smaller than the segment duration (negative test), the frame element is simply encoded directly at step 608, i.e. timing attributes flagged to signal presence/absence of frame information along with any content related to styling information or multiplexed values.

These values may be further compressed with a deflate algorithm for better efficiency.

It should be noted that from one SC section to another, the dictionary is reset to guarantee the access without inter-dependency from one compressed metadata segment to another.

Finally, each SC section generated by the EXI-based compressor at step 308 provides a new compressed metadata segment 107 to place on the HTTP server 108 for streaming with the associated video segment during transmitting step 203.

EXI compressor 309 therefore contains an extension compared to a standard EXI encoder as it enables the self-contained option to be used on more than one element.

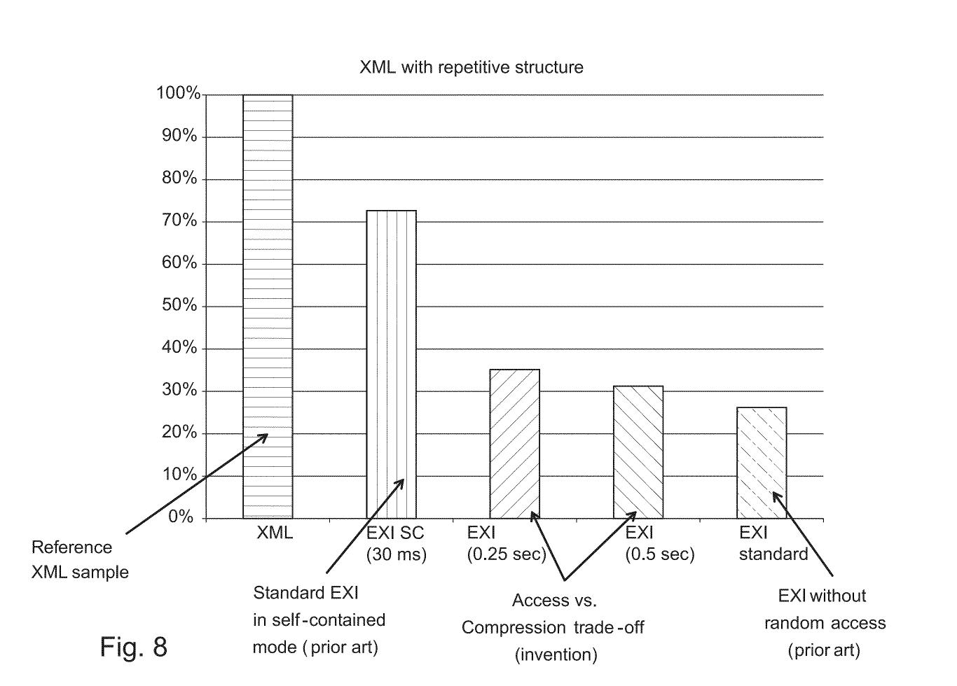

Access granularity can therefore be controlled and compression efficiency may be preserved as illustrated on FIG. 8.

The curves on this figure show the compression efficiency between different compression modes with respect to the original size of an XML document.

On the right side stands the standard EXI compression with default option which does not provide random access in the compressed stream.

This mode, though most efficient in terms of compression (even when not considering the schema mode), is not convenient in an HTTP streaming scheme in which it is desirable to have the streaming client 110 progressively downloading the metadata segments 107 in parallel with video segments 101 as reminded on FIG. 1.

However, obtaining this progressive download requires temporal access in the EXI compressed stream.

The self-contained option of the EXI specification provides this random access, yet this feature applies onto no more than one element at a time, thus degrading compression performance, as shown on FIG. 8.

The result of compression step 202 preserves compression efficiency while providing control on the access granularity.

This is enabled thanks to the signalization of an extended SC section which is itself implicit thanks to the SC event that indicates the beginning of the section and to the ED event that indicates the end of the section.

It should be noted that the number of elements between these two markers has no importance, meaning that this new feature for self-containment has a no cost in terms of syntax modification—the only need to enable such encoding is to enable the application to indicate the EXI compressor 309 that it has to terminate the SC section.

Thus, the control moves from EXI encoder internal processing to the application level, resulting in the performance shown on FIG. 8.

Although the present invention has been described hereinabove with reference to specific embodiments, the present invention is not limited to the specific embodiments, and modifications will be apparent to a skilled person in the art which lie within the scope of the present invention.

Many further modifications and variations will suggest themselves to those versed in the art upon making reference to the foregoing illustrative embodiments, which are given by way of example only and which are not intended to limit the scope of the invention, that being determined solely by the appended claims. In particular the different features from different embodiments may be interchanged, where appropriate.

In the claims, the word “comprising” does not exclude other elements or steps, and the indefinite article “a” or “an” does not exclude a plurality.

The mere fact that different features are recited in mutually different dependent claims does not indicate that a combination of these features cannot be advantageously used.

1. A method of transmitting metadata documents associated with a video, each metadata document comprising format information and time information, comprising the steps of:
identifying, within every metadata document, distinct elements by their format information and storing elements of equivalent format within sets;
multiplexing, within each set, elements of common time information;
compressing at least one of the said multiplexed elements; and
transmitting a bit-stream containing said at least one multiplexed element.

2. A method according to claim 1, wherein the multiplexing step includes the mapping of the elements from a same set onto an abstract representation format.

3. A method according to claim 1, comprising the additional step of choosing between at least two different multiplexing algorithms.

4. A method according to claim 3, wherein the multiplexing algorithm consists in assembling elements of equivalent format into a single frame element defined by the union of the intersections of the time intervals found between the time information of said elements of equivalent format.

5. A method according to claim 3, wherein the multiplexing algorithm consists in assembling elements of equivalent format into one or more frame elements defined by the intersection of the time interval found between the time information of said elements of equivalent format.

6. A method according to claim 1, wherein a plurality of the multiplexed elements are grouped into segments, the compressing step being performed independently on each segment.

7. A method according to claim 6, wherein the segment compression is performed by using the efficient XML interchange (EXI) format.

8. A method according to claim 6, wherein the number of multiplexed elements within a segment is based upon the segment duration information provided in a multimedia document containing a description of the video.

9. A method according to claim 8, wherein said size of the segment is used as a criterion for compressing, by using the self-contained option of the efficient XML interchange format, for more than one element.

10. A method according to claim 9, wherein each value of the elements in the segment are further compressed using a deflate algorithm

11. A method according to claim 9, wherein the values of the elements in the segment are encoded using the compression option of the efficient XML interchange format.

12. A metadata transmitter for synchronizing metadata documents associated with a video, each metadata document comprising format information and time information, comprising:
an identifier for identifying, within every metadata document, distinct elements by their format information and storing elements of equivalent format within sets;
a multiplexing encoder for multiplexing, within each set, elements of common time information;
a compressor for compressing at least one of the said multiplexed elements; and
a transmitter for transmitting a bit-stream containing said at least one multiplexed elements.

13. A method of progressively receiving metadata documents associated with a video that is described in multimedia documents, comprising the steps of:
receiving compressed multiplexed elements of metadata documents;
un-compressing the received multiplexed elements;
reconstructing different metadata documents from the obtained multiplexed elements;
associating these metadata documents to the corresponding video multimedia documents for rendering.
